(19) United States
(12) Patent Application Publication
(10) Pub. No.: US 2018/0359140 A1
(43) Pub. Date: Dec. 13, 2018

(54) METHOD, DEVICE, AND SYSTEM FOR PROCESSING A TERMINAL FAULT

(71) Applicant: SHENZHEN TCL DIGITAL TECHNOLOGY LTD., Shenzhen City, Guandong (CN)

(72) Inventors: Guoding JIANG, Shenzhen City, Guandong (CN); Junping KANG, Shenzhen City, Guandong (CN)

(21) Appl. No.: 15/781,066

(22) PCT Filed: Jun. 2, 2016
(86) PCT No.: PCT/CN2016/084465

§ 371 Date: Jun. 1, 2018

(30) Foreign Application Priority Data
Dec. 2, 2015 (CN) 201510872273.X

(51) Int. Cl. H04L 12/24

(52) U.S. Cl. CPC H04L 41/0686; H04L 41/069

(57) ABSTRACT

Disclosed is a method for processing a terminal fault, the method including: in response to detection of a fault, obtaining, by a terminal, a current fault code based on a preset fault code table; generating fault information according to the fault code; and invoking a fault active reporting interface to send the fault information, a fault file, and the terminal's identification information to a server, so that the server stores associatively the fault information, the fault file, and the terminal's identification information, where the fault file includes a log file. Further disclosed is a device for processing a terminal fault. The efficiency of handling a terminal fault is improved.

### RELATED APPLICATIONS

The present application is a National Phase of International Application Number PCT/CN2016/084465, filed Jun. 2, 2016, and claims the priority of China Application No. 201510872273.X, filed Dec. 2, 2015.

### TECHNICAL FIELD

This disclosure relates to the field of terminal technologies, and more particularly relates to a method, a device, and a system for processing a terminal fault.

### BACKGROUND

With the constant development of science and technology, terminals such as smart phones and smart televisions have become mainstream in the market and have gained wide applications. In the prior art, a log file of the terminal system is stored in a ring buffer. When a new log file is generated, some old log file is overwritten. After the log file corresponding to a terminal fault is overwritten by other log files, the engineer cannot locate and analyze the terminal fault based on the log file. Instead, the engineer can only perform analysis and processing with respect to the problem fed back by the user based on experience and knowledge. However, mistakes may occur relying on experience and knowledge, leading to a low fault handling efficiency.

### SUMMARY

It is therefore one main object of this disclosure to provide a method, a device, and a system for processing a terminal fault, aiming to solve the technical problem of low efficiency of existing terminal fault processing.

To achieve the above object, this disclosure provides a method for processing a terminal fault, the method including the following operations. In response to detection of a fault, a terminal obtains a current fault code based on a preset fault code table. The terminal then generates fault information according to the fault code. The terminal then invokes a fault active reporting interface to send the fault information, a fault file, as well as the terminal's identification information to a server, so that the server stores associatively the fault information, the fault file, and the terminal's identification information. The fault file includes a log file.

In some embodiments, the block of the terminal invoking the fault active reporting interface to send the fault information, the fault file, and the terminal's identification information to the server so that the server stores associatively the fault information, the fault file, and the terminal's identification information includes the following operations. The terminal invokes the fault active reporting interface to send the fault information and the terminal's identification information to the server, where in the case the fault information and the terminal's identification information are not stored on the server, or in the case a time difference between a fault time of the fault information stored on the server and a fault time of the currently received fault information is greater than a preset threshold duration, the server feeds back a response message for uploading the fault file. Then in response to reception of the response message, the terminal sends the fault file to the server so that the server stores the fault file associatively with the fault information and the terminal's identification information.

In some embodiments, the method further includes the following operation, subsequent to the block of the terminal sending the fault file to the server so that the server stores the fault file associatively with the fault information and the terminal's identification information: deleting the fault file in response to reception of a save success message sent by the server.

In some embodiment, the block of the terminal generating the fault information according to the fault code includes the following operations. A fault type of the fault is determined. When the fault type is a system fault, a fault application package name corresponding to the system fault is obtained, and the fault information is generated using the fault application package name and the fault code. Otherwise when the fault type is an application fault, then the fault code is used as the fault information.

In addition, in order to achieve the foregoing object, this disclosure further provides a device for processing a terminal fault, the device including: an acquiring module configured to obtain a current fault code based on a preset fault code table when a terminal detects a fault; a generating module configured to generate fault information according to the fault code; and a transmitting module configured to invoke a fault active reporting interface and to send the fault information, a fault file, as well as the terminal's identification information to a server, so that the server stores associatively the fault information, the fault file, and the terminal's identification information, wherein the fault file includes a log file.

In some embodiments, the transmitting module is configured to: invoke the fault active reporting interface to send the fault information and the terminal's identification information to the server, where in the case the fault information and the terminal's identification information are not stored on the server, or in the case a time difference between a fault time of the fault information stored on the server and a fault time of the currently received fault information is greater than a preset threshold duration, the server feeds back a response message for uploading the fault file; and in response to reception of the response message, send the fault file to the server so that the server stores the fault file associatively with the fault information and the terminal's identification information.

In some embodiments, the device further includes: a deleting module configured to delete the fault file in response to reception of a save success message sent by the server.

In some embodiments, the generating module includes: a determining unit configured to determine a fault type of the fault; and a generating unit configured to, when the fault type is a system fault, obtain a fault application package name corresponding to the system fault, and to generate the fault information using the fault application package name and the fault code; and otherwise when the fault type is an application fault, use the fault code as the fault information.

In addition, in order to achieve the above object, this disclosure further provides a system for processing a terminal fault, the system includes a terminal and a server. The terminal is configured to: in response to detection of a fault, obtain a current fault code based on a preset fault code table, and generate fault information according to the fault code; and invoke a fault active reporting interface to send the fault information, a fault file, and the terminal's identification information to the server. The server is configured to, in response to reception of the fault information, the fault file, and the terminal's identification information sent by the terminal, store associatively the fault information, the fault file, and the terminal's identification information.

In some embodiments, the server is configured to: in response to reception of the fault information and the terminal's identification information sent by the terminal, send to the terminal a response message for uploading the fault file so that the terminal feeds back the fault file, if the fault information and the terminal's identification information are not stored on the server or if a time difference between a fault time of the fault information stored on the server and a fault time of the currently received fault information is greater than a preset threshold duration; and in response to reception of the fault file, store the fault file associatively with the fault information and the terminal's identification information.

According to the method, device, and system for processing a terminal fault that are provided by this disclosure, upon detection of a fault, the terminal invokes a fault active reporting interface to send the fault information and a fault file corresponding to the fault, as well as the terminal's identification information to a server. Then the server stores associatively the received fault information, fault file, and terminal's identification information. Thus, the engineer does not need to analyze and handle the fault based on experience and knowledge. Instead, the engineer can accurately locate and then process the terminal's fault based on the associatively stored fault information, fault file, and terminal's identification information after logging in to the server. Therefore, the fault handling efficiency is improved.

### BRIEF DESCRIPTION OF THE ACCOMPANYING DRAWINGS

FIG. 1 is an illustrative flowchart of a first embodiment of a method for processing a terminal fault in accordance with this disclosure.

FIG. 2 is a detailed flowchart illustrating the operation of invoking a fault active reporting interface to send the fault information, a fault file, as well as the terminal's identification information to a server in a second embodiment of the method for processing a terminal fault in accordance with this disclosure.

FIG. 3 is an illustrative functional block diagram of a first embodiment of a device for processing a terminal fault in accordance with this disclosure.

FIG. 4 is an illustrative structural diagram of a system for processing a terminal fault in accordance with this disclosure.

### DETAILED DESCRIPTION OF ILLUSTRATIVE EMBODIMENTS

It will be understood that the specific embodiments described herein are merely illustrative of the disclosure and are not intended to limit the disclosure.

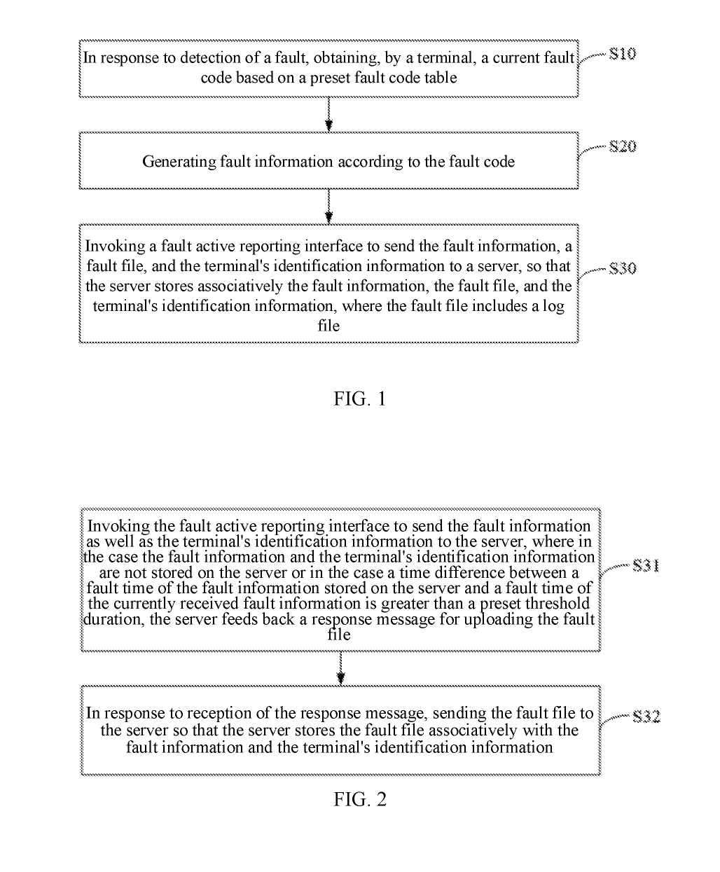

This disclosure provides a method for processing a terminal fault. Referring to FIG. 1, which is an illustrative flowchart of a first embodiment of the method for processing a terminal fault in accordance with this disclosure.

In this embodiment, the method includes the following blocks S10 to S30.

In S10, in response to detection of a fault, a terminal obtains a current fault code based on a preset fault code table. The method then proceeds to block S20.

In S20, fault information is generated according to the fault code.

The terminal mentioned in this disclosure includes, but is not limited to, a smart television, a smart phone, and the like. In this embodiment, the fault code table of the terminal is set in advance. Each type of fault of the terminal is uniformly represented by a fault code. For example, the fault code format may be implemented as a 32-bit format, where the higher 16 bits represent a module number, while the lower 16 bits represent an exception number. For example, an Audio module may be represented by 0x0003, a Launcher module may be represented by 0x0010, and a player module may be represented by 0x0020. The exception number represents a fault of a module. Different faults can be represented by different exception numbers. However, the same exception number can also be used to represent different faults of different modules. For example, when the module number is 0x0003, the exception number 0x0001 may represent an illegal parameter. When the module number is 0x0010, the exception number 0x0001 may indicate that the version is low. When the module number is 0x0020, the exception number 0x0001 may indicate that the format is not supported. In other words, the fault code 0x00030001 indicates that the Audio module parameter is an illegal parameter, fault code 0x00100001 indicates that the version of the Launcher module is low, and fault code 0x00200001 indicates that the player module format is not supported. The fault code table is preloaded in the terminal. Typically, in this embodiment, a fault processing method table corresponding to the fault code table is also set in advance, where in the fault processing method table is set a fault processing method corresponding to each fault code. For example, the corresponding fault processing method for fault code 0x00030001 may be set as “Forward to R&D: xxx@163.com for handling” so as to transfer the terminal fault to the specified personnel for processing. The corresponding fault processing method for fault code 0x00100001 may be “download the latest version from the application store”. The corresponding fault processing method for fault code 0x00200001 may be “upgrade the system version to the latest version”.

When it detects a fault, the terminal obtains the corresponding fault code of the fault based on the fault code table. For example, when there occurs a fault that the Audio module parameter is an illegal parameter, fault code 0x00030001 is obtained. When there occurs a fault that the version of the Launcher module is low, fault code 0x00100001 is obtained. When there occurs a fault that the player module format is not supported, fault code 0x00200001 is obtained. Based on the obtained fault code, the terminal generates the corresponding fault description information of the fault code, and then generates the corresponding fault information of this fault based on the fault code and the fault description information. At the same time, the fault file corresponding to the fault is obtained, the fault file including a log file, a configuration file, and the like. The method then continues to block S30.

In S30, a fault active reporting interface is invoked to send the fault information, the fault file, as well as the terminal's identification information to a server, so that the server stores associatively the fault information, the fault file, and the terminal's identification information.

In this embodiment, the terminal stores the identification information of the terminal such as a terminal model number and a terminal ID number. When the terminal obtains the fault information and fault file corresponding to the fault, the terminal invokes the fault active reporting interface to send the obtained fault information and fault file, as well as the terminal's identification information to the corresponding server. For example, the terminal may invoke the fault active reporting interface to send the fault information, the fault file, as well as the terminal's identification information to a fault active reporting service message queue, so that the fault active reporting service message queue can be used to send the fault information, the fault file, and the terminal's identification information to the server through HTTP POST.

After receiving the fault information, the fault file, and the terminal's identification information, the server stores associatively the fault information, the fault file, and the terminal's identification information. Typically, the server also stores a fault code table and a corresponding fault processing method table. After that, the engineer logs in to the server. Thus, by viewing the terminal's identification information saved thereon, the engineer can find out the faulty terminal. Based on the fault code table, the engineer would be able to accurately locate and analyze the terminal's fault through the saved fault information and fault file. Meanwhile, the engineer can also obtain the method for processing this fault based on the fault processing method table.

According to the solution provided by this embodiment, when it detects a fault, the terminal obtains a current fault code based on a preset fault code table, generates fault information, and further invokes a fault active reporting interface to send the fault information, a fault file, as well as the terminal's identification information to a server. The server stores associatively the received fault information, fault file, and the terminal's identification information. As such, the engineer can log in to the server and would be able to accurately locate the terminal's fault based on the fault information, the fault file, and the terminal's identification information that are associatively stored, so that the fault can further be handled. Therefore, the fault handling efficiency is improved. Meanwhile, the effect of remotely troubleshooting the terminal is also improved, thereby improving the user experience.

As illustrated in FIG. 2, there is further provided a second embodiment of the method for processing a terminal fault according to this disclosure on the basis of the first embodiment. In this embodiment, the block S30 includes the following steps S31 to S32.

In S31, a fault active reporting interface is invoked to send the fault information and the terminal's identification information to the server, where in the case the fault information and the terminal's identification information are not stored on the server, or in the case a time difference between a fault time of the fault information stored on the server and a fault time of the currently received fault information is greater than a preset threshold duration, the server feeds back a response message for uploading the fault file.

In the first embodiment, each time it finds itself in a fault, the terminal sends the fault information, the fault file and the terminal's identification information to the server. As a result, the server may be overloaded considering the server's system storage capacity. To avoid this problem, based on the first embodiment, in this embodiment when it obtains the fault information and the fault file corresponding to the fault, the terminal invokes the fault active reporting interface and first sends only the fault information and the terminal's identification information to the server. For example, the terminal may invoke the fault active reporting interface to send the fault information and the terminal's identification information to the fault active reporting service message queue, so that the fault active reporting service message queue can be used to send the fault information and the terminal's identification information to the server through HTTP POST.

After receiving the fault information and the terminal's identification information, the server queries whether the fault information and the terminal's identification information are stored on the server. When it is found that the fault information and the terminal's identification information are not stored on the server, it indicates that the terminal before has not transmitted the fault information, the terminal's identification information, and the fault file corresponding to the same fault. In this case, the server saves the fault information and the terminal's identification information. For example, the server may store the fault information and the terminal's identification information in a database. Then the server returns to the terminal a message for uploading the fault file. For example, it can be set in advance that uploading the fault file corresponds to identifier 1, while not uploading the fault file corresponds to identifier 0. After saving the fault information and the terminal's identification information, the server returns a response message carrying identifier 1 to the terminal. When it is found that the fault information and the terminal's identification information are stored on the server, it indicates that the terminal before has transmitted the fault information, the terminal's identification information, and the fault file corresponding to the same fault. The server may save the received fault information and the terminal's identification information in the database, and then returns to the terminal a response message for not uploading the fault file, e.g., returns a response message carrying identifier 0 to the terminal. Alternatively, the server may also not save the received fault information and the terminal's identification information, and directly returns to the terminal a response message for not uploading the fault file.

Further, in this embodiment, the fault information corresponding to the terminal fault may further include a fault time. During its use, the terminal may undergo system updates and version upgrades. Thus, for the same type of fault, the fault file corresponding to this fault the terminal obtains before a system update or version upgrade may be different than the fault file corresponding to this fault the terminal obtains after the system update or version upgrade. In this case, after the terminal sends the fault information and the terminal's identification information corresponding to this fault to the server, the server finds that the fault information and the terminal's identification information are stored on the server, which indicates that the terminal before has sent the fault information, the terminal's identification information, and the fault file that correspond to this fault. At this time, the server returns to the terminal a response message for not uploading the fault file. In fact, however, the fault file corresponding to this fault that is saved by the server may be different from the fault file corresponding to this fault that is currently obtained by the terminal. As such, the engineer may not be able to effectively solve the fault problem based on the fault file stored by the server. In order to avoid this from happening, in this embodiment a preset threshold duration is further set in advance. For example, the preset threshold duration may be set to a period of one week. When it finds that the fault information and the terminal's identification information are stored thereon, the server further determines whether a time difference between a fault time of the saved fault information and a fault time of the currently received fault information is greater than the preset threshold duration. When the time difference between the fault time of the saved fault information and the fault time of the currently received fault information is less than or equal to the preset threshold duration, it indicates that the terminal has the same fault in a short period of time, but usually the terminal will not perform system upgrades and version upgrades in a short time. As such, the server may return a response message to the terminal for not uploading the fault file. When the time difference between the fault time of the stored fault information and the fault time of the currently received fault information is greater than the preset threshold duration, then it indicates that it has been a period of time since last time the terminal had the same fault, such that the fault file corresponding to the fault saved by the server may be different from the fault file corresponding to the fault currently obtained by the terminal. As such, the server may save the received fault information, fault time, and the terminal's identification information. Optionally, the server may delete the previously saved fault information, fault time, fault file, and terminal's identification information that correspond to this fault. The server returns a response message for uploading the fault file.

In S32, in response to reception of the response message, the fault file is sent to the server so that the server stores the fault file associatively with the fault information and the terminal's identification information.

When it receives from the server the response message for uploading the fault file, the terminal sends the fault file corresponding to the fault to the server. For example, the terminal may compress and package the fault file corresponding to the fault before sending it to the server through HTTP POST. When the server receives the fault file, it stores the fault file associatively with the fault information and the terminal's identification information. Typically, the server stores the storage address of the fault file in the database in which the fault information and the terminal's identification information are stored. After storing the fault file associatively with the fault information and the terminal's identification information, the server returns a save success message to the terminal.

Further, in this embodiment, the method may further include the following step a subsequent to step S32.

In step a, the fault file is deleted in response to reception of the save success message sent by the server.

After the server returns the save success message to the terminal and the terminal receives the save success message, namely after the fault file has been successfully stored in the server, the terminal deletes the fault file in the terminal. As a result, the terminal gains more storage space.

Further, in this embodiment, the block S20 may include the following steps b to d.

In step b, a fault type of the fault is determined.

In step c, when the fault type is a system fault, a fault application package name corresponding to the system fault is obtained, and the fault information is generated using the fault application package name and the fault code.

In step d, when the fault type is otherwise an application fault, the fault code is used as the fault information.

Terminal faults usually fall into two categories, system faults and application faults. Upon detection of a fault, the terminal determines the fault type of the fault while obtaining the current fault code based on the preset fault code table. If the fault type is a system fault, the fault information corresponding to the system fault may include the fault code, the fault description information, the name of the fault application package that causes the system fault, and so on. Otherwise if the fault type is an application fault, then the fault information corresponding to the application fault may include the fault code, the fault description information, and so on. Thus, when it determines that the fault is a system fault, the terminal may further obtain the fault application package name corresponding to the system fault, and then generates the fault information using the fault application package name and the fault code. Otherwise when the fault type is an application fault, then the fault code is used as the fault information. Typically, for some simple application faults, the fault information is enough for accurately locating and analyzing the fault without needing the fault file. Therefore, the engineer can set in advance that for each of various application faults whether the fault file needs to be sent to the server. When it detects that the fault type is an application fault and for this application fault the fault file needn't be sent to the server, then the terminal may directly send the fault information and the terminal's identification information corresponding to this application fault to the server for saving. As such, the engineer would be able to handle the terminal's application faults based on the saved fault information and terminal's identification information.

According to the solution provided by this embodiment, the terminal invokes the fault active reporting interface to first send the fault information and the terminal's identification information to the server. After receiving the fault information and the terminal's identification information, the server returns to the terminal a response message for uploading the fault file when detecting that the fault information and the terminal's identification information are not stored on the server or when a time difference between the fault time of the fault information stored on the server and the fault time of the currently received fault information is greater than a preset threshold duration. Then when receiving the response message for uploading the fault file, the terminal sends the fault file to the server so that the server stores the fault file associatively with the fault information and the terminal's identification information. This solves the problem that the fault file is sent to the server at every fault causing the server to be overloaded.

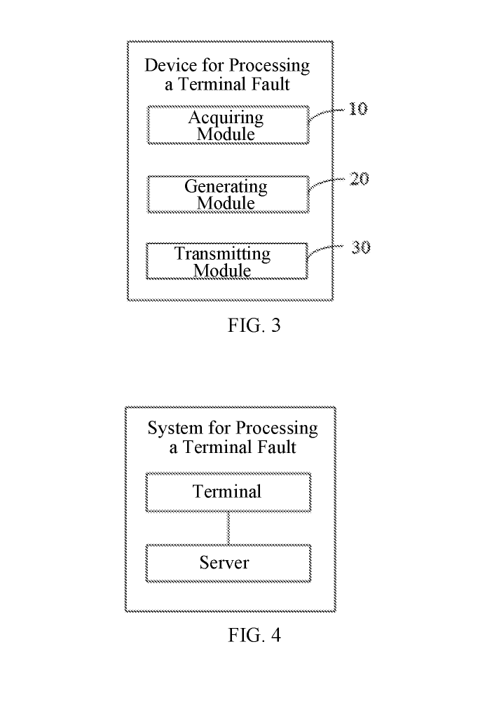

This disclosure further provides a device for processing a terminal fault. Referring to FIG. 3, which is an illustrative functional block diagram of the device for processing a terminal fault in accordance with this disclosure.

In this embodiment, the device includes an acquiring module 10, a generation module 20, and a transmitting module 30.

The acquiring module 10 is configured to obtain a current fault code based on a preset fault code table when a terminal detects a fault.

The generating module 20 is configured to generate fault information according to the fault code.

The terminal mentioned in this disclosure includes, but is not limited to, a smart television, a smart phone, and the like. In this embodiment, the fault code table of the terminal is set in advance. Each type of fault of the terminal is uniformly represented by a fault code. For example, the fault code format may be implemented as a 32-bit format, where the higher 16 bits represent a module number, while the lower 16 bits represent an exception number. For example, an Audio module may be represented by 0x0003, a Launcher module may be represented by 0x0010, and a player module may be represented by 0x0020. The exception number represents a fault of a module. Different faults can be represented by different exception numbers. However, the same exception number can also be used to represent different faults of different modules. For example, when the module number is 0x0003, the exception number 0x0001 may represent an illegal parameter. When the module number is 0x0010, the exception number 0x0001 may indicate that the version is low. When the module number is 0x0020, the exception number 0x0001 may indicate that the format is not supported. In other words, the fault code 0x00030001 indicates that the Audio module parameter is an illegal parameter, fault code 0x00100001 indicates that the version of the Launcher module is low, and fault code 0x00200001 indicates that the player module format is not supported. The fault code table is preloaded in the terminal. Typically, in this embodiment, a fault processing method table corresponding to the fault code table is also set in advance, where in the fault processing method table is set a fault processing method corresponding to each fault code. For example, the corresponding fault processing method for fault code 0x00030001 may be set as “Forward to R&D: xxx@163.com for handling” so as to transfer the terminal fault to the specified personnel for processing. The corresponding fault processing method for fault code 0x00100001 may be “download the latest version from the application store”. The corresponding fault processing method for fault code 0x00200001 may be “upgrade the system version to the latest version”.

When the terminal detects a fault, the acquiring module 10 obtains the corresponding fault code of the fault based on the fault code table. For example, when there occurs a fault that the Audio module parameter is an illegal parameter, fault code 0x00030001 is obtained. When there occurs a fault that the version of the Launcher module is low, fault code 0x00100001 is obtained. When there occurs a fault that the player module format is not supported, fault code 0x00200001 is obtained. At the same time, the acquiring module 10 obtains the fault file corresponding to the fault, the fault file including a log file, a configuration file, and the like. Based on the obtained fault code, the generating module 20 generates the corresponding fault description information of the fault code, and then generates the corresponding fault information of this fault based on the fault code and the fault description information.

The transmitting module 30 is configured to invoke a fault active reporting interface to send the fault information, the fault file, as well as the terminal's identification information to a server, so that the server stores associatively the fault information, the fault file, and the terminal's identification information.

In this embodiment, the terminal stores the identification information of the terminal such as a terminal model number and a terminal ID number. When the fault information and fault file corresponding to the fault are obtained, the transmitting module 30 invokes the fault active reporting interface to send the obtained fault information and fault file, as well as the terminal's identification information to the corresponding server. For example, the transmitting module 30 may invoke the fault active reporting interface to send the fault information, the fault file, as well as the terminal's identification information to a fault active reporting service message queue, so that the fault active reporting service message queue can be used to send the fault information, the fault file, and the terminal's identification information to the server through HTTP POST.

After receiving the fault information, the fault file, and the terminal's identification information, the server stores associatively the fault information, the fault file, and the terminal's identification information. Typically, the server also stores a fault code table and a corresponding fault processing method table. After that, the engineer logs in to the server. Thus, by viewing the terminal's identification information saved thereon, the engineer can find out the faulty terminal. Based on the fault code table, the engineer would be able to accurately locate and analyze the terminal's fault through the saved fault information and fault file. Meanwhile, the engineer can also obtain the method for processing this fault based on the fault processing method table.

According to the solution provided by this embodiment, after the acquiring module 10 obtains a current fault code based on a preset fault code table and the generating module 20 generates the fault information according to the fault code, the transmitting module 30 invokes a fault active reporting interface to send the fault information, a fault file, as well as the terminal's identification information to a server. The server stores associatively the received fault information, fault file, and the terminal's identification information. As such, the engineer can log in to the server and would be able to accurately locate the terminal's fault based on the fault information, the fault file, and the terminal's identification information that are associatively stored, so that the fault can further be handled. Therefore, the fault handling efficiency is improved. Meanwhile, the effect of remotely troubleshooting the terminal is also improved, thereby improving the user experience.

There is further provided a second embodiment of the device for processing a terminal fault according to this disclosure on the basis of the above first embodiment. In this embodiment, the transmitting module 30 is configured to: invoke the fault active reporting interface to send the fault information and the terminal's identification information to the server, where in the case the fault information and the terminal's identification information are not stored on the server, or in the case a time difference between a fault time of the fault information stored on the server and a fault time of the currently received fault information is greater than a preset threshold duration, the server feeds back a response message for uploading the fault file; and in response to reception of the response message, send the fault file to the server so that the server stores the fault file associatively with the fault information and the terminal's identification information.

In the first embodiment, each time it finds itself in a fault, the transmitting module 30 sends the fault information, the fault file and the terminal's identification information to the server. As a result, the server may be overloaded considering the server's system storage capacity. To avoid this problem, based on the first embodiment, in this embodiment when the fault information and the fault file corresponding to the fault are obtained, the transmitting module 30 invokes the fault active reporting interface and first sends only the fault information and the terminal's identification information to the server. For example, the transmitting module 30 may invoke the fault active reporting interface to send the fault information and the terminal's identification information to the fault active reporting service message queue, so that the fault active reporting service message queue can be used to send the fault information and the terminal's identification information to the server through HTTP POST.

After receiving the fault information and the terminal's identification information, the server queries whether the fault information and the terminal's identification information are stored on the server. When it is found that the fault information and the terminal's identification information are not stored on the server, it indicates that the terminal before has not transmitted the fault information, the terminal's identification information, and the fault file corresponding to the same fault. In this case, the server saves the fault information and the terminal's identification information. For example, the server may store the fault information and the terminal's identification information in a database. Then the server returns to the terminal a message for uploading the fault file. For example, it can be set in advance that uploading the fault file corresponds to identifier 1, while not uploading the fault file corresponds to identifier 0. After saving the fault information and the terminal's identification information, the server returns a response message carrying identifier 1 to the terminal. When it is found that the fault information and the terminal's identification information are stored on the server, it indicates that the terminal before has transmitted the fault information, the terminal's identification information, and the fault file corresponding to the same fault. The server may save the received fault information and the terminal's identification information in the database, and then returns to the terminal a response message for not uploading the fault file, e.g., returns a response message carrying identifier 0 to the terminal. Alternatively, the server may also not save the received fault information and the terminal's identification information, and directly returns to the terminal a response message for not uploading the fault file.

Further, in this embodiment, the fault information corresponding to the terminal fault may further include a fault time. During its use, the terminal may undergo system updates and version upgrades. Thus, for the same type of fault, the fault file corresponding to this fault the terminal obtains before a system update or version upgrade may be different than the fault file corresponding to this fault the terminal obtains after the system update or version upgrade. In this case, after the transmitting module 30 invokes the fault active reporting interface to send the fault information and the terminal's identification information corresponding to this fault to the server, the server finds that the fault information and the terminal's identification information are stored on the server, which indicates that the terminal before has sent the fault information, the terminal's identification information, and the fault file that correspond to this fault. At this time, the server returns to the terminal a response message for not uploading the fault file. In fact, however, the fault file corresponding to this fault that is saved by the server may be different from the fault file corresponding to this fault that is currently obtained by the terminal. As such, the engineer may not be able to effectively solve the fault problem based on the fault file stored by the server. In order to avoid this from happening, in this embodiment a preset threshold duration is further set in advance. For example, the preset threshold duration may be set to a period of one week. When it finds that the fault information and the terminal's identification information are stored thereon, the server further determines whether a time difference between a fault time of the saved fault information and a fault time of the currently received fault information is greater than the preset threshold duration. When the time difference between the fault time of the saved fault information and the fault time of the currently received fault information is less than or equal to the preset threshold duration, it indicates that the terminal has the same fault in a short period of time, but usually the terminal will not perform system upgrades and version upgrades in a short time. As such, the server may return a response message to the terminal for not uploading the fault file. When the time difference between the fault time of the stored fault information and the fault time of the currently received fault information is greater than the preset threshold duration, then it indicates that it has been a period of time since last time the terminal had the same fault, such that the fault file corresponding to the fault saved by the server may be different from the fault file corresponding to the fault currently obtained by the terminal. As such, the server may save the received fault information, fault time, and the terminal's identification information. Optionally, the server may delete the previously saved fault information, fault time, fault file, and terminal's identification information that correspond to this fault. The server returns a response message for uploading the fault file.

When the response message for uploading the fault file is fed back from the server, the transmitting module 30 sends the fault file corresponding to the fault to the server. For example, the transmitting module 30 may compress and package the fault file corresponding to the fault before sending it to the server through HTTP POST. When the server receives the fault file, it stores the fault file associatively with the fault information and the terminal's identification information. Typically, the server stores the storage address of the fault file in the database in which the fault information and the terminal's identification information are stored. After storing the fault file associatively with the fault information and the terminal's identification information, the server returns a save success message to the terminal.

In this embodiment, the device for processing a terminal fault may further include a deleting module configured to delete the fault file in response to reception of a save success message sent by the server.

After the server returns the save success message to the terminal and the save success message is received, namely after the fault file has been successfully stored in the server, the deleting module deletes the fault file in the terminal. As a result, the terminal gains more storage space.

Further, in this embodiment, the generating module 20 includes: a determining unit configured to determine a fault type of the fault; and a generating unit configured to, when the fault type is a system fault, obtain a fault application package name corresponding to the system fault, and to generate the fault information using the fault application package name and the fault code; and otherwise when the fault type is an application fault, use the fault code as the fault information.

Terminal faults usually fall into two categories, system faults and application faults. When the terminal detects a fault, after the acquiring module 10 obtains the current fault code based on the preset fault code table, the determining unit determines the fault type of the fault. If the fault type is a system fault, the fault information corresponding to the system fault may include the fault code, the fault description information, the name of the fault application package that causes the system fault, and so on. Otherwise if the fault type is an application fault, then the fault information corresponding to the application fault may include the fault code, the fault description information, and so on. Thus, when the determining unit determines that the fault is a system fault, the generating unit may further obtain the fault application package name corresponding to the system fault, and then generates the fault information using the fault application package name and the fault code. Otherwise when the fault type is an application fault, then the fault code is used as the fault information. Typically, for some simple application faults, the fault information is enough for accurately locating and analyzing the fault without needing the fault file. Therefore, the engineer can set in advance that for each of various application faults whether the fault file needs to be sent to the server. When the determining module determines that the fault type is an application fault and for this application fault the fault file needn't be sent to the server, then the transmitting module 30 may invoke the fault active reporting interface and directly send the fault information and the terminal's identification information corresponding to this application fault to the server for saving. As such, the engineer would be able to handle the terminal's application faults based on the saved fault information and terminal's identification information.

According to the solution provided by this embodiment, the transmitting module 30 invokes the fault active reporting interface to first send the fault information and the terminal's identification information to the server. After receiving the fault information and the terminal's identification information, the server returns a response message for uploading the fault file when detecting that the fault information and the terminal's identification information are not stored on the server or when a time difference between the fault time of the fault information stored on the server and the fault time of the currently received fault information is greater than a preset threshold duration. Then when the response message for uploading the fault file is received, the transmitting module 30 sends the fault file to the server so that the server stores the fault file associatively with the fault information and the terminal's identification information. This solves the problem that the fault file is sent to the server at every fault causing the server to be overloaded.

This disclosure further provides a system for processing a terminal fault. Referring to FIG. 4, which is an illustrative structural diagram of an embodiment of the system for processing a terminal fault in accordance with this disclosure.

In this embodiment, the terminal is configured to: in response to detection of a fault, obtain a current fault code based on a preset fault code table, and generate fault information according to the fault code; and invoke a fault active reporting interface to send the fault information, a fault file, and the terminal's identification information to the server.

The server is configured to, in response to reception of the fault information, the fault file, and the terminal's identification information sent by the terminal, store associatively the fault information, the fault file, and the terminal's identification information.

In the system for processing a terminal fault according to this disclosure, when it detects a fault, the terminal obtains a fault code corresponding to the fault based on a preset fault code table, and then generates fault information, and further sends the fault information, a fault file as well as the terminal's identification information to the server.

When receiving the fault information, the fault file, and the terminal's identification information sent by the terminal, the server stores associatively the fault information, the fault file, and the terminal's identification information. After that, the engineer logs in to the server. Thus, by viewing the terminal's identification information saved thereon, the engineer can find out the faulty terminal. Based on the fault code table, the engineer would be able to accurately locate and analyze the terminal's fault through the saved fault information and fault file. Meanwhile, the engineer can also obtain the method for processing this fault based on the fault processing method table.

Further, the terminal invokes the fault active reporting interface and first sends only the fault information and the terminal's identification information to the server. After receiving the fault information and the terminal's identification information sent by the terminal, the server queries whether the fault information and the terminal's identification information are stored on the server. When it finds that the fault information and the terminal's identification information are not stored thereon, the server sends a response message to the terminal for uploading the fault file. Otherwise when it finds that the fault information and the terminal's identification information are stored thereon, the server further detects whether a time difference between a fault time of the stored fault information and a fault time of the currently received fault information is greater than a preset threshold duration. When the time difference between the fault time of the stored fault information and the fault time of the currently received fault information is greater than the preset threshold duration, the server sends to the terminal the response message for uploading the fault file. When it receives from the server the response message for uploading the fault file, the terminal sends the fault file corresponding to the fault to the server. After receiving the fault file sent by the terminal, the server stores the fault file associatively with the fault information and the terminal's identification information.

According to the solution provided by this embodiment, when it detects a fault, the terminal obtains a fault code corresponding to the fault based on a preset fault code table, generates fault information, and further sends the fault information, a fault file, as well as the terminal's identification information to a server. After receiving the fault information, the fault file, and the terminal's identification information that are sent by the terminal, the server stores associatively the received fault information, fault file, and the terminal's identification information. As such, the engineer can log in to the server and would be able to accurately locate the terminal's fault based on the fault information, the fault file, and the terminal's identification information that are associatively stored, so that the fault can further be handled. Therefore, the fault handling efficiency is improved. Meanwhile, the effect of remotely troubleshooting the terminal is also improved, thereby improving the user experience.

Furthermore, it will be apparent to those skilled in the art that this disclosure also provides a device for processing a terminal fault, the device including a non-transitory program storage medium and one or more processors. The non-transitory program storage medium stores program code executable by the one or more processors to perform the various methods and processes described supra. In addition, it will be apparent to those skilled in the art that various modules or units 10, 20, and 30 as illustrated in FIG. 3 can be software modules or software units. In another aspect, it is well-known that various software modules or units inherently can be stored in the non-transitory program storage medium and executed by the one or more processors.

The foregoing description merely portrays some illustrative embodiments according to the disclosure and therefore is not intended to limit the patentable scope of the disclosure. Any equivalent structural or flow transformations that are made taking advantage of the specification and accompanying drawings of the disclosure and any direct or indirect applications thereof in other related technical fields shall all fall in the scope of protection of the disclosure.

1. A method for processing a terminal fault, comprising:
in response to detection of a fault, obtaining, by a terminal, a current fault code based on a preset fault code table;
generating fault information according to the fault code; and
invoking a fault active reporting interface to send the fault information, a fault file, and identification information of the terminal to a server, so that the server stores associatively the fault information, the fault file, and the identification information of the terminal, in which the fault file comprises a log file.

2. The method of claim 1, wherein the block of invoking the fault active reporting interface to send the fault information, the fault file, and the identification information of the terminal to the server so that the server stores associatively the fault information, the fault file, and the identification information of the terminal comprises:
invoking the fault active reporting interface to send the fault information and the identification information of the terminal to the server, wherein when the fault information and the identification information of the terminal are not stored on the server, or when a time difference between a fault time of the fault information stored on the server and a fault time of the currently received fault information is greater than a preset threshold duration, the server feeds back a response message for uploading the fault file; and
in response to reception of the response message, sending the fault file to the server so that the server stores the fault file associatively with the fault information and the identification information of the terminal.

3. The method of claim 2, further comprising, subsequent to sending the fault file to the server so that the server stores the fault file associatively with the fault information and the identification information of the terminal:
deleting the fault file in response to reception of a save success message sent by the server.

4. The method of claim 1, wherein generating the fault information according to the fault code comprises:
determining a fault type of the fault;
when the fault type is a system fault, obtaining a fault application package name corresponding to the system fault, and generating the fault information using the fault application package name and the fault code; and
otherwise when the fault type is an application fault, using the fault code as the fault information.

5. The method of claim 2, wherein generating the fault information according to the fault code comprises:
determining a fault type of the fault;
when the fault type is a system fault, obtaining a fault application package name corresponding to the system fault, and generating the fault information using the fault application package name and the fault code; and
otherwise when the fault type is an application fault, using the fault code as the fault information.

6. The method of claim 3, wherein generating the fault information according to the fault code comprises:
determining a fault type of the fault;
when the fault type is a system fault, obtaining a fault application package name corresponding to the system fault, and generating the fault information using the fault application package name and the fault code; and
otherwise when the fault type is an application fault, using the fault code as the fault information.

7. A device for processing a terminal fault, comprising one or more processors and a non-transitory program storage medium storing program code executable by the one or more processors, the program code comprising:
an acquiring module, configured to obtain a current fault code based on a preset fault code table when a terminal detects a fault;
a generating module, configured to generate fault information according to the fault code; and
a transmitting module, configured to invoke a fault active reporting interface to send the fault information, a fault file, and identification information of the terminal to a server, so that the server stores associatively the fault information, the fault file, and the identification information of the terminal, wherein the fault file comprises a log file.

8. The device of claim 7, wherein the transmitting module is configured to:
invoke the fault active reporting interface to send the fault information and the identification information of the terminal to the server, wherein when the fault information and the identification information of the terminal are not stored on the server, or when a time difference between a fault time of the fault information stored on the server and a fault time of the currently received fault information is greater than a preset threshold duration, the server feeds back a response message for uploading the fault file; and
in response to reception of the response message, send the fault file to the server so that the server stores the fault file associatively with the fault information and the identification information of the terminal.

9. The device of claim 8, wherein the program code further comprises:
a deleting module, configured to delete the fault file in response to reception of a save success message sent by the server.

10. The device of claim 7, wherein the generating module comprises:
a determining unit, configured to determine a fault type of the fault; and
a generating unit, configured to, when the fault type is a system fault, obtain a fault application package name corresponding to the system fault, and to generate the fault information using the fault application package name and the fault code; and otherwise when the fault type is an application fault, use the fault code as the fault information.

11. The device of claim 8, wherein the generating module comprises:
a determining unit, configured to determine a fault type of the fault; and
a generating unit, configured to: when the fault type is a system fault, obtain a fault application package name corresponding to the system fault, and to generate the fault information using the fault application package name and the fault code; and otherwise when the fault type is an application fault, use the fault code as the fault information.

12. The device of claim 9, wherein the generating module comprises:
a determining unit, configured to determine a fault type of the fault; and
a generating unit, configured to: when the fault type is a system fault, obtain a fault application package name corresponding to the system fault, and to generate the fault information using the fault application package name and the fault code; and otherwise when the fault type is an application fault, use the fault code as the fault information.

13. A system for processing a terminal fault, the system comprising a terminal and a server, wherein:
the terminal is configured to: in response to detection of a fault, obtain a current fault code based on a preset fault code table, and generate fault information according to the fault code; and invoke a fault active reporting interface to send the fault information, a fault file, and identification information of the terminal to the server;
the server is configured to, in response to reception of the fault information, the fault file, and the identification information of the terminal sent by the terminal, store associatively the fault information, the fault file, and the identification information of the terminal.

14. The system of claim 13, wherein the server is configured to:
in response to reception of the fault information and the terminal's identification information sent by the terminal, send to the terminal a response message for uploading the fault file so that the terminal feeds back the fault file, if the fault information and the identification information of the terminal are not stored on the server or if a time difference between a fault time of the fault information stored on the server and a fault time of the currently received fault information is greater than a preset threshold duration; and
in response to reception of the fault file, store the fault file associatively with the fault information and the identification information of the terminal.
